(19) United States
(12) Patent Application Publication
(10) Pub. No.: US 2010/0040426 A1
(43) Pub. Date: Feb. 18, 2010

(54) FIXATION DEVICE FOR A PORTABLE DRILLING UNIT

(75) Inventor: Bjorn Pettersson, Jarfalla (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Novator AB, Spanga (SE)

(21) Appl. No.: 12/530,659

(22) PCT Filed: Apr. 22, 2008
(86) PCT No.: PCT/SE08/50453

§ 371 Date: Sep. 10, 2009

Related U.S. Application Data
(60) Provisional application No. 60/914,327, filed on Apr. 27, 2007.

(51) Int. Cl. B23B 45/14; B23B 49/02

(52) U.S. Cl. 408/115 B; 408/115 R

(57) ABSTRACT

A fixation device for positioning and fixating a portable drilling machine onto a guide bushing on a template, wherein a single locating pin is associated with the guide bushing and extends axially through a separate hole in the drill template adjacent to the guide bushing. A clamping mechanism of the device is configured to concentrically circumscribe a portion of the guide bushing and has a recess for simultaneous engagement with the single locating pin in order to positively lock the housing and a drilling machine attached thereto circumferentially in a predetermined position.

### BACKGROUND OF THE INVENTION

The present invention relates to a fixation device for positioning and fixating a portable drilling unit, such as an orbital drilling unit, to a drill template when cutting holes in an object, especially holes that have a larger diameter than the diameter of the cutting tool. The fixation device includes a clamping mechanism which is detachably coupled to a distal end of the drilling unit and configured to be detachably connected to a guide bushing fixedly secured in a hole of the drill template during machining of a hole or recess in the adjacent object to which the template is attached. More particularly, the fixation device relates to a fixation device of the kind set forth in the preamble of claim 1.

Orbital drilling machines are previously known; cf. e.g. U.S. Pat. No. 6,663,327 B2, and U.S. Pat. No. 6,719,505 B2, the contents of which are incorporated herein by reference. Such orbital machining devices are usually constructed as hand held or portable tool apparatuses which are especially suitable for drilling a plurality of holes or recesses in workpieces comprising fiber-reinforced composite materials and laminates, wherein the drilling unit in itself provides for an orbital movement of a rotating cutting tool which is positively governed by the an integrated excenter mechanism of a spindle unit.

When machining materials using a portable or hand tool, many advantages are achieved due to the flexible positioning of the tool and degrees of freedom of motion of the tool with respect to the workpiece. The advantages of using a portable or hand tool include the ability to position the tool in positions not possible by a stationary tool, overhead for example, or to position the tool and machine a workpiece that is part of a larger assembly, such may occur when producing a plurality of holes in an aircraft or during a repair operation thereof. Machining a workpiece with a curved (or other non flat geometry) surface can be made easier with a portable or hand tool due to the inherent positioning flexibility.

Additionally, templates are used in conjunction with machine tools to easily replicate a workpiece pattern. When using templates the machine tool is guided by the template pattern requiring the motion of the machine tool to be constrained by the template pattern. The use of a template with a portable or hand tool can be problematic due to the inherent positioning flexibility and degrees of freedom of motion of the tool which now must be constrained to follow the template pattern.

WO 02/102535 A1 discloses a fixation device for a portable orbital drilling unit comprising a clamping mechanism for detachably connecting the drilling unit to either two locating pins attached diametrically opposed and proximate to each hole in the template (FIGS. 1 and 2), or, in accordance with the preamble of claim 1, to a single hollow locating guide bushing (FIGS. 3 and 4) defining an aperture concentric with the respective template hole and through which the cutting tool of the drilling unit may be axially and radially advanced into the workpiece while rotating about its own longitudinal center axis and orbiting eccentrically about a principal axis. In the embodiment of FIGS. 3 and 4, the clamping mechanism comprises a cylindrical ball holder carrying a plurality of circumferentially spaced locking balls which may be displaced into locking engagement with an outer circumferential groove of the single guide bushing by means of an outer, axially movable pressure cylinder so as to axially and rotationally fixate the drilling unit relative to the template. The pressure cylinder is urged towards its extended locking position by the force of a bias spring acting on a piston connected to the pressure cylinder. The piston may be moved by air pressure in the opposite direction to release the locking action of the balls in the circumferential groove in the guide bushing.

Another fixation device is disclosed in U.S. Pat. No. 6,971,824 B1, wherein a locking ball holder is configured as a pneumatically actuated, axially movable piston, and an inner tapered portion of an outer stationary housing acts to depress each ball into locking engagement with an annular groove of a guide bushing.

If, in case of clamping mechanisms having a single guide bushing, the rotating cutting tool for any reason is jammed in the workpiece, this could result in an undesired rotation of the entire drilling unit, since a high torque will be generated which may break the frictional locking engagement of the clamping mechanism with the guide bushing. Also, access problems may arise when positioning and fixating the drilling unit correctly in a circumferential sense onto the guide bushing due to the normally asymmetrical configuration of the housing of the drilling unit. This may especially be the case where template holes are situated in narrow and confined spaces.

### SUMMARY OF THE INVENTION

An object of the present invention is to provide a fixation device for mounting a portable drilling unit to a drill template and configured such that the drilling unit always may be positively fixated axially and in a desired predetermined rotary position to a single locating guide bushing during a working cycle. To this end the fixation device of the present invention is characterized by the features set forth in claim 1. Thus, the guide bushing of the fixation device of the present invention, which fits snugly in a predrilled hole of the drill template, is associated with a separate, radially offset, axial locating pin configured to extend through a separate predrilled hole in the template and to protrude from an outer surface of the drill template so as to be able to be engaged by an associated pin-receiving recess of the clamping mechanism. This pin-receiving recess may be formed as a groove in a distal end section of the cylindrical ball holder.

Preferably, the guide bushing has a radial attachment flange having a plurality of circumferentially spaced apertures for receiving screws for fixating the bushing on the back side of the drill template. This flange may axially support the locating pin in its mounted position.

According to another aspect of the invention a unique, individual hole-information carrier containing an identification of the hole to be formed may be mounted in a recess substantially diametrically opposed to the locating pin adjacent to each guide hole in the template. The information carrier may consist of any suitable type of readable ID, such as a RFID tag or chip and contain all relevant information of the respective hole to be formed, such as type of hole, various processing and dimensional parameters thereof, e.g. diameter, depth and configuration of the hole, cutting advancement speed, countersinks, etc. The information of e.g. an RFID chip may be identified by a reader or a sensor of the orbital drilling machine through an antenna located close to the RFID chip on the clamping mechanism.

According to still another aspect of the invention the piston of the clamping mechanism, which axially displaces the pressure cylinder for urging the locking balls into their locked position in the groove of the guide bushing, is a double-acting pneumatic sleeve-like piston. Circumferentially spaced compression springs may act on the side of the piston which displaces the piston in a ball-locking direction, and pressurized air is applied to the opposite side of the piston to displace the latter against the action of the springs so as to release the balls from their locking position in the bushing groove. Since the piston is a double-action pneumatic piston, pressureized air introduced into a chamber on the spring side of the piston may be utilized to increase the clamping force exerted on the balls in the bushing groove. In a suitable embodiment this pressurized air may also be used to clean a reference contact surface of the inner end of the guide bushing when attaching the drilling unit to the guide bushing and to check whether a proper surface contact has been achieved between the inner end of the guide bushing and the component (ball holder) of the clamping mechanism supported on and engaging said end surface. For this purpose air ducts extend from the air chamber on the spring side of the piston and open into the respective contact surfaces of the ball holder. A pressure sensor connected to said air chamber may be adapted to give an alarm as an indication of incorrect locking in case a pressure fall is detected.

The above-mentioned and other features and advantages of this invention, and the manner of attaining them, will become more apparent and the invention will be better understood by reference to the following description of an embodiment of the invention taken in conjunction with the accompanying drawings.

### BRIEF DESCRIPTION OF THE DRAWINGS

FIG. 1 is a schematic cross-sectional view of a clamping mechanism for an orbital drilling machine in an unlocked position on a guide bushing;

FIG. 2 is a cross-sectional side view of the clamping mechanism in FIG. 1 in its locked position on the guide bushing;

FIG. 3 is a view similar to FIGS. 1 and 2 but in a rotationally different cross-section illustrating an air duct for cleaning the supporting end reference surface of the guide bushing;

FIG. 4 is a schematic perspective view of the distal end of the clamping mechanism;

FIG. 5 is a schematic top perspective view of the guide bushing with a locating pin and an RFID chip for use together with the clamping mechanism of the present invention;

FIG. 6 is a schematic bottom perspective view of the guide bushing in FIG. 5; and

FIG. 7 is a view from above of guide bushings mounted in a drill template.

### DETAILED DESCRIPTION OF A PREFERRED EMBODIMENT

FIGS. 1-3 disclose a clamping mechanism 10 for detachably connecting an orbital drilling unit (not shown) to a drill template 12 which is attached adjacent to a workpiece (not shown), e.g. a structural component of an aircraft, and provided with a plurality of predrilled guide holes 14 located in a predetermined pattern corresponding to the positions of the holes to be drilled in the workpiece. Each guide hole 14 houses a hollow guide bushing 16 to which the drilling unit is to be fixedly secured by means of the clamping mechanism 10 during a hole machining process.

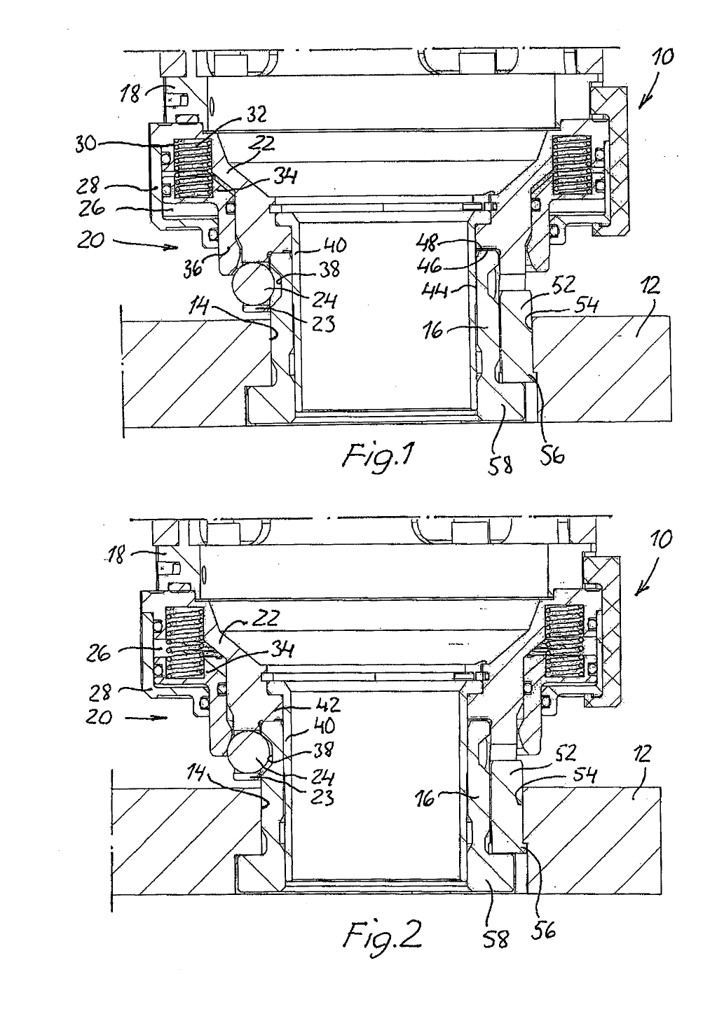

The clamping mechanism 10 comprises a housing 18 which, at one end, is detachably coupled (not shown) to the drilling unit and at the other end connected to a fixation unit 20. The fixation unit 20 comprises a radially inner cylindrical part 22, the axially inner end of which is attached to the housing 18, whereas the axially outer end thereof forms a holder 23 for at least one but preferably a plurality of locking balls 24, e.g. five balls which are evenly spaced circumferentially and movable radially. The axially inner end of part 22 also delimits a pneumatic chamber 26 together with a radially outer cylindrical part 28 and has recesses 30 for receiving therein one end of compression springs 32 evenly distributed around the inner end of the cylindrical part 22. The other end of the compression springs 32 acts on top of an annular piston member 34 which is slidable in the chamber 26. An axially outer end of the piston member 34 forms a cylindrical pressure sleeve 36 configured to co-act with the locking balls 24 so as to push the locking balls 24 into a locking engagement with an outer annular groove 38 of the guide bushing 16, when the piston member 34 and the pressure sleeve 36 is displaced axially outwardly by the combined action of the compression springs 32 and pressurized air introduced into the spring side of the chamber 26, as shown in FIG. 2.

An inner guide sleeve 40 supported by an inwardly directed shoulder 42 of the inner cylindrical part 22 fits snugly into the hole 44 of the guide bushing 16 and secures the drilling unit radially relative to the guide bushing 16. In the locked position of the clamping mechanism 10 and the drilling unit on the hollow guide bushing 16 lands 46 (FIG. 4) on the lower side of the inwardly directed shoulder 42 of the inner cylindrical part 22 is steadily supported by an axially inner end surface 48 of the guide bushing 16. These structural measures will secure the drilling unit not only radially but also axially and circumferentially.

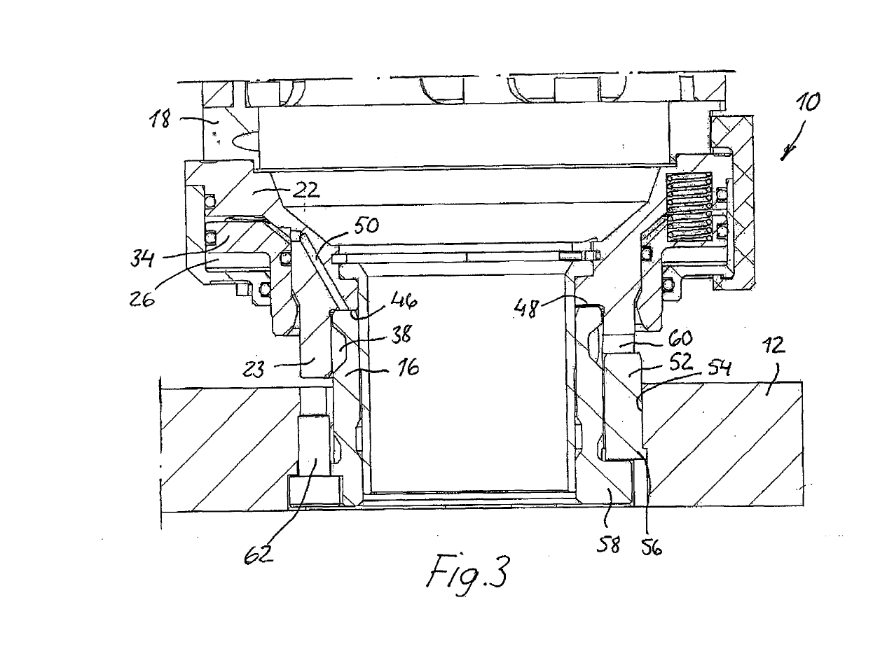

Air ducts 50 (FIG. 3) communicate the spring side of the chamber 26 with the lands 46 so as to provide means for cleaning the inner end surface 48 of the guide bushing 16 with pressurized air prior to the attachment of the clamping mechanism 10 onto the guide bushing 16. A pressure sensor (not shown) connected to the air chamber 26 may be adapted to give an alarm as an indication of an incorrect locking in case a pressure fall is detected by the sensor.

As seen in FIG. 1, in order to release the balls 24 from the locking engagement with the groove 38 of the guide bushing 16, pressurized air is introduced into the chamber 26 on the opposite (lower) side of the annular piston member 34 so as to displace the piston member 34 and the pressure sleeve 36 axially inwardly against the action of the compression springs 32. This will allow the locking balls 24 to move radially outwardly so that the drilling unit may be lifted off the guide bushing 16.

Although the locking balls 24 will normally provide a sufficient clamping action on the guide bushing to prevent the drilling unit from moving circumferentially in case the cutting tool for any reason is jammed in the workpiece, according to the present invention a locating pin 52 may be associated with the guide bushing 16 order to positively lock the drilling unit circumferentially. As shown in FIGS. 1-3, 5 and 7, the locating pin 52 may extend axially through a separate hole 54 in the drill template 12 adjacent to the guide bushing 16. Preferably, a foot 56 of the pin 52 may be supported on an upper surface of a lower flange 58 of the guide bushing 16, whereas the upper end of the locating pin 52 may project into a groove-like recess 60 (FIG. 4) on the lower end surface of the ball holder 23. The guide bushing 16 is attached to the drill template 12 by fastening screws 62.

The locating pin 52 will provide for not only a positive locking circumferentially of the drilling unit but also allow for a suitable predetermined rotary position of the drilling unit relative to the guide bushing, given the normally asymmetrical configuration of the housing of the drilling unit. This may especially be the case where the template holes are situated in narrow and confined spaces.

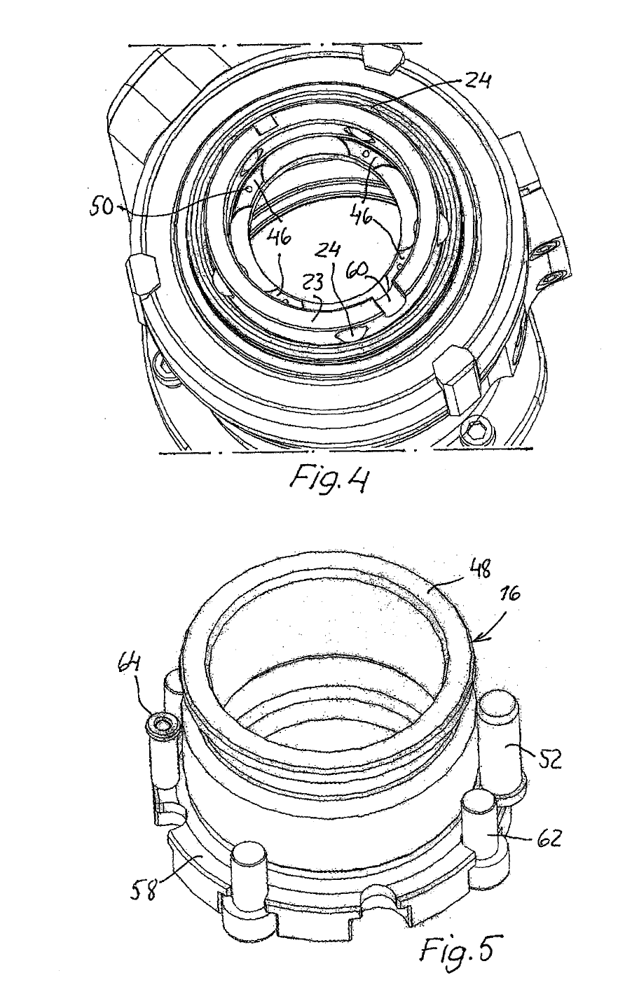

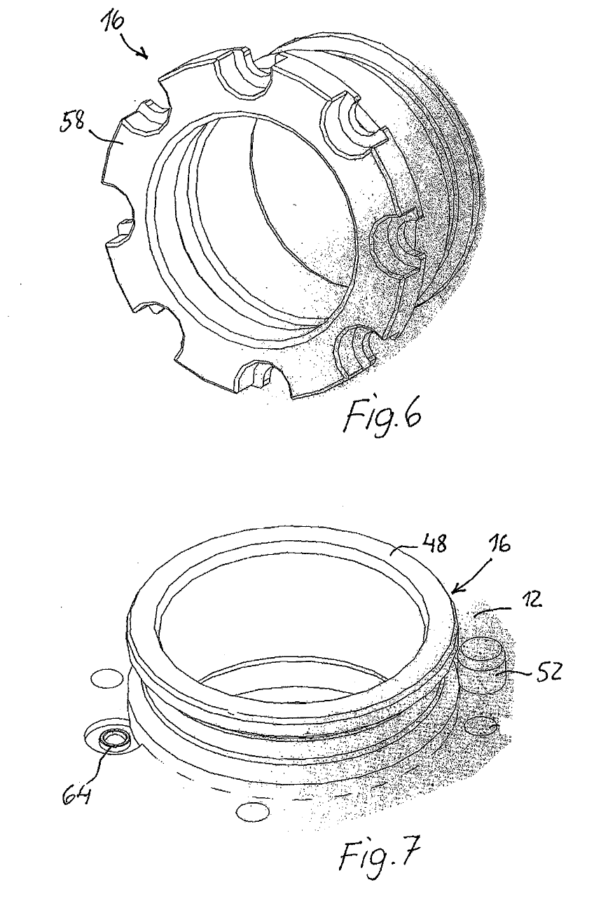

According to the invention a unique, individual hole-information carrier 64 (FIGS. 5 and 7) containing an identification of the hole to be formed may be mounted in a recess substantially diametrically opposed to the locating pin 52 adjacent to each guide hole 14 in the drill template 12. The information carrier 64 may consist of any suitable type of readable ID, such as a RFID tag or chip and contain all relevant information of the respective hole to be formed, such as type of hole, various processing and dimensional parameters thereof, e.g. diameter, depth and configuration of the hole, cutting advancement speed, countersinks, etc. The information of e.g. an RFID chip 64 may be identified by a reader or a sensor (not shown) of the orbital drilling machine through an antenna (not shown) located close to the RFID chip 64 in the template 12.

1. A fixation device for positioning and fixating a portable drilling machine onto a template having at least one hole and a locating guide bushing inserted in said hole and projecting outwardly from the template, said fixation device comprising:
a housing with a first, proximal end for coupling with the drilling machine and a second, distal end; and
a clamping mechanism at the second, distal end of the housing for detachably connecting said housing to the locating guide bushing, said clamping mechanism including a piston-like sleeve slidable within a cylinder chamber and having a piston proximal end surface and a piston distal end surface, a clamping actuator configured to act on the piston proximal end surface for forcing the piston towards a locking position of the housing on the guide bushing, an unclamping actuator configured to act on the piston distal end surface in a direction opposite to the action of the clamping actuator, a shaft section of the piston-like sleeve forming at a distal end thereof a ball holder configured to concentrically circumscribe a portion of the guide bushing protruding from the template, and at least one locking ball located in an aperture of the ball holder, said guide bushing including an annular groove in which said at least one locking ball engages during actuation of said clamping actuator and disengages during actuation of said unclamping actuator, wherein a separate locating pin is associated with the guide bushing and extends axially through a separate hole in the drill template adjacent to the guide bushing, and the clamping mechanism has a recess for receiving the locating pin in order to positively lock the housing and a drilling machine attached thereto circumferentially in a predetermined position.

2. The fixation device of claim 1, wherein a foot of the locating pin is supported on a flange of the guide bushing.

3. The fixation device of claim 1, wherein the pin-receiving recess is formed as a groove on a distal end of the ball holder.

4. The fixation device of claim 1, wherein the clamping actuator includes a plurality of circumferentially arranged compression springs.

5. The fixation device of claim 1, wherein the clamping actuator includes a pneumatic system acting on the piston proximal end surface.

6. The fixation device of claim 5, wherein at least one air duct communicates the side of the chamber actuated by the clamping actuator with a distal support surface of the clamping mechanism for engagement with a proximal end surface of the guide bushing.

7. The fixation device of claim 1, wherein the unclamping actuator includes a pneumatic system acting on the piston distal end surface.

8. The fixation device of claim 1, wherein an individual hole-information carrier containing an identification of the hole to be formed is mounted adjacent to the guide bushing in the drill template.

9. The fixation device of claim 8, wherein the hole-information carrier is mounted substantially diametrically opposed to the drill template.

10. The fixation device of claim 8, wherein the hole-information carrier is a RFID chip.
